(19) United States
(12) Patent Application Publication
(10) Pub. No.: US 2006/0164226 A1
(43) Pub. Date: Jul. 27, 2006

(54) Turn indicator warning device

(76) Inventor: Charles Wayne Hartle, Salt Lake City, UT (US)

Correspondence Address: Charles Wayne Hartle, 4555 Aspen Hollow Lane, Salt Lake City, UT, 84117, US

(21) Appl. No.: 11/034,357

(22) Filed: Jan. 13, 2005

(51) Int. Cl. B60Q 1/00; B60Q 1/34

(52) U.S. Cl. 340/457; 340/475

(57) ABSTRACT

A turn indicator warning device that may be installed on an automobile having a standard turn indicator system so that when the turn indicator lights are continuing to operate after a period of on-time the operator can manually turn off the turn indicator lights of the automobile together with the warning device.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

1. Field of the Invention

This invention relates to indicator signal lights and audible alarms for use in automobiles to indicate to a driver when a turn indicator signal is in use.

For many years, it has been required that automobiles include turn indicator lights that will indicate to oncoming and following drivers that a driver of a automobile is planning to turn the vehicle to the left or to the right.

2. Prior Art

It has become common in connection with turn indicator lights that blink on and off in advance of a turn that an automobile operator manipulate an indicating control lever by raising or lowering the control lever dependent on the direction the operator plans to turn the automobile. As is well known, if the control lever is pulled down, the front and rear indicator lights, outside of the vehicle, on the left side of the vehicle blink. Similarly, if the indicator control lever is raised the front and rear indicator lights, outside of the automobile, on the right side of the automobile blink. It is also well known that the signal indicator lights are arranged to be automatically turned off and the lever automatically moves to a central position upon completion of the turn that has been signaled. However, it is also common that from time-to-time, the turn indicator lights do not turn off and the lever does not return to a central position after a turn has been completed. This is particularly true where a gradual turn is made in the automobile and the system for turning off the blinking lights does not work effectively.

Also, when an automobile operator is signaling that he is preparing to change the travel of the automobile, the operator may pull the indicator lever down or raise it up and then after having performed the lane change operation with the automobile may forget to move the lever back to the centered position. In such instance, the indicator lights on the vehicle will continue to flash and in many cases the operator fails to respond to the audible sound or the flashing light indicating that the outside indicator lights are still flashing. It may be, for example, that a radio inside the automobile is preventing the driver from hearing an audible signal and the driver may not be paying sufficient attention to the blinking lights inside the vehicle to know that the outside signaling lights continue to operate. Continued operation of the signal lights beyond the intended time period can cause confusion to other drivers and may be dangerous.

In the past, some automobiles have been manufactured to include a back-up warning system that provides a distinct alarm system when the indicator lights have remained on and the automobile has been driven a pre-determined number of miles.

### BRIEF SUMMARY OF THE INVENTION

### OBJECTS OF THE INVENTION

Principal objects of the present invention are to provide a warning device that will be activated to allow a pre-determined period of time after actuation by the driver of the outside indicator lights to blink and to indicate to oncoming and following drivers that the driver of the automobile is preparing to make a turn to the right or to the left.

Another object is to provide a secondary warning system that will positively alert a driver that his blinker indicator lights, indicating an anticipated turn of the automobile, whether to turn a corner or to change lanes, has continued to operate beyond the time necessary for such indication.

Still another object is to provide an add-on type system that can be readily attached to existing automobiles and to the indicator light systems of such automobiles to provide a warning to a driver that the turn indicator lights have failed to turn off.

### FEATURES OF THE INVENTION

Principal features of the warning system of the present invention include circuitry that will, following a time period after activation of a turn indicator light system of an automobile, turn on an additional warning light and/or sound apparatus to warn that the initially activated turn indicator light system is continuing to operate.

Another features is that the warning system of the present invention is readily adapted to use on existing automobiles, including those manufactured without such a warning system.

Other features include an additional audible and/or visual warning system that will continue to operate until the automobile turn indicator lights are turned off.

Additional objects and features of the invention will become apparent to persons skilled in the art to which the invention pertains from the following detailed description and claims.

### BRIEF DESCRIPTION OF THE FIGURES OF THE INVENTION

In the Drawings

FIG. 1 is pictorial view of a instrument panel in the front area of a vehicle showing the alarm and warning light and buzzer of the invention positioned to alert a driver;

FIG. 2, a block diagram of the circuit of the invention;

FIG. 3, a typical circuit of the invention; and

FIG. 4, a flow diagram showing the sequence of operation of the components of the invention.

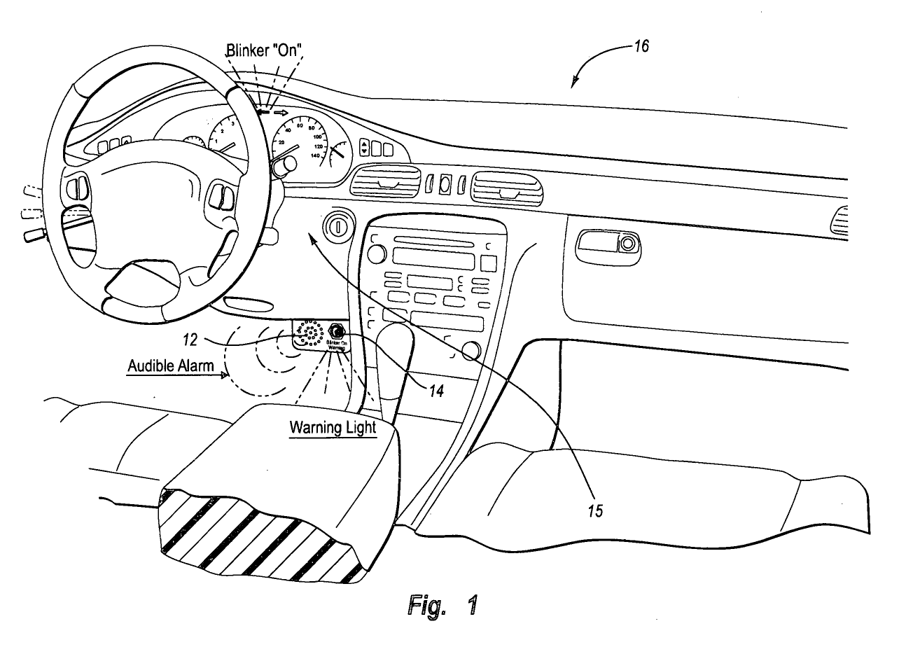

### DETAILED DESCRIPTION

Referring Now the Drawings

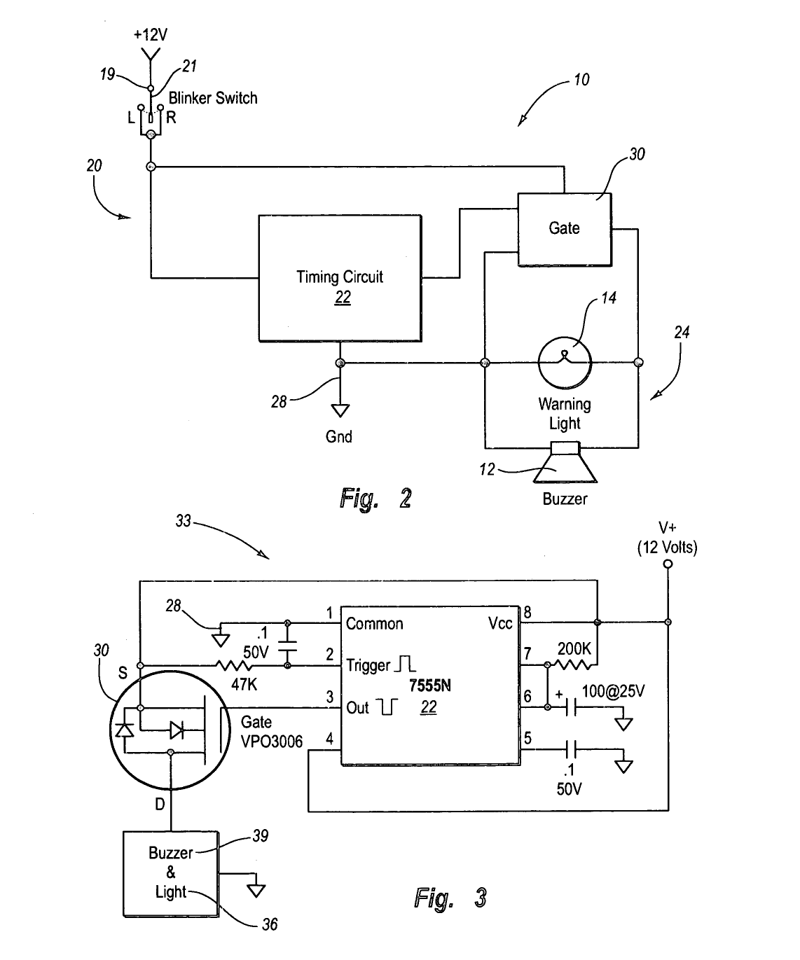

In the illustrated preferred embodiment of the invention, the turn indicator warning device of the invention is shown generally at 10, FIG. 2. Device 10 includes an audible alert device as shown at 12, and a visual alarm comprising a warning light 14 that will come on and that preferably blinks, positioned adjacent to the audible alert and affixed to some location in the dashboard area 15 of a automobile shown generally at 16. Device 10 includes circuitry 20, as shown generally in FIG. 2 and, more specifically, in FIG. 3. Referring particularly to FIG. 2, it can be seen that power to the circuitry 20 comes from the power source to the blinker switch 19 normally provided on an automobile and operated by lever 21. The circuitry 20 further includes a timing circuit 22 and a warning system shown generally at 24. The timing circuit 22 and warning system 24 have a common ground 28 and a gate 30 is provided between the timing circuit 22 and the warning system 24.

A typical satisfactory control circuit, is shown at 33 in FIG. 3 to include the necessary element values that will provide for actuation of the warning device, including a buzzer 34 and light 36 of the warning system.

The VP 0300L is a P channel FET and may be a TO-92 package available from Siliconix, Inc.

To increase the delay time before device 10 is started, either R or C can be changed by use of IP pin 6. To decrease the time delay it is only necessary to reduce the value of R and/or C.

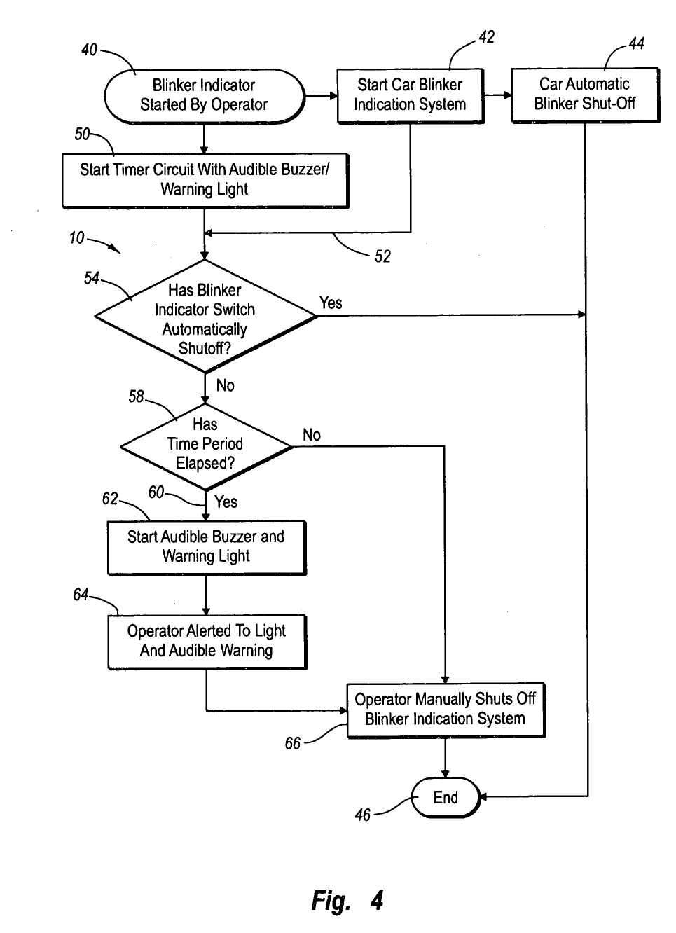

Operation of the device 10 is best understood with reference to the flow diagram of FIG. 4.

The device 10 works in the manner shown best in FIG. 4. As shown at 40, conventional blinker indicators of an automobile are started by an operator of the automobile in a conventional manner.

Operation of the blinker indicator, as shown at 40, starts the automobile blinker indicating system as shown at 42. Under normal circumstances, the automobile blinker is automatically turned off, as shown at 44. In this case no further blinking and associated noise function will continue. The cycle comes to an end as shown at 46.

At the same time, the blinker indicator is turned on at 40 a voltage signal is sent, as shown at 50, to start the timer circuit of the audible buzzer 12 and warning light 14 of the warning device 10.

The voltage signal 50 and a signal 52 from the car blinker indicator system 42 go to a detection circuit 54 at which location it is determined whether or not the blinker indicator switch has automatically shut off. If so, the voltage provided by the blinking indicator 40 has stopped the circuit, goes to end 46 and the device 10 is not further operated.

If the voltage signal continues, it triggers a timer circuit as shown at 58. If a pre-set time period has elapsed, a voltage signal 50 triggers the above system 60 to start operation of an audible device, i.e., buzzer 12 and a warning light 14, as shown at 62.

Operation of the alarm device then alerts the vehicle operator to cancel the car blinkers by shutting off the blinker indicator.

If the time period for operation of the vehicle blinker has not been completed, the operator can manually operate the control lever to cancel operation of the blinker indicator system.

The device 10 is easily connected to the usual turn indicator signally switch of an automobile and can be readily retro-fitted to automobiles not having a warning system to indicate to a driver that his usual signal light indicator has failed to shut off the signaling lights.

Although a preferred embodiment of my invention has been herein described, it is to be understood that the present disclosure is by way of example and that variations are possible without departing from the subject matter coming within the scope of the following claims, which subject matter I regard as my invention.

I claim:

1. A turn indicator warning device comprising
a warning means mounted to provide an alert to a driver of an automobile having a standard turn indicator light system operated through a switch turned on by the automobile operator; and
circuit means for the warning means connected to the switch whereby actuation of said switch provides power to said circuit means and said circuit means further including timer means and means for turning on the warning means after said timer means has been activated for a pre-determined time and means to turn off said warning device upon turning off of said standard turn indicator light system.

2. A turn indicator warning device as in claim 1, wherein the circuit means further includes
an alarm system supplemental to the standard light indicator system.

3. A turn indicator warning device as in claim 2, wherein
the alarm system includes an audible alarm signal and a light.

4. A turn indicator warning device as in claim 3, wherein
the circuit means includes means for turning off the circuit means upon deactivation of the turn indicator.
